(19) United States
(12) Patent Application Publication
(10) Pub. No.: US 2007/0187922 A1
(43) Pub. Date: Aug. 16, 2007

(54) Self powered collapsible bicycle

(76) Inventor: Peter A. Boutakis, Markham (CA)

Correspondence Address: GEORGE A. ROLSTON, 45 SHEPPARD AVE EAST, SUITE 900, TORONTO, ON, M2N5W9, CA

(21) Appl. No.: 11/353,103

(22) Filed: Feb. 14, 2006

(51) Int. Cl. B62K 15/00

(52) U.S. Cl. 280/287

(57) ABSTRACT

A self extending, collapsible bicycle, which is self extending upon the operation of a simple control, and having: collapsible frame portions moveable between collapsed and extended positions, self-powering devices connecting the frame portions which are operable to extend the frame portions, and a control connected to the self powering devices.

### FIELD OF THE INVENTION

The invention relates to a collapsible bicycle and in particular to a collapsible bicycle which has the ability to erect itself into its upright rideable position upon the operation of a simple control.

### BACKGROUND OF THE INVENTION

Many different proposals have been made for building collapsible bicycles. Bicycles having folding frames, folding forks, moveable wheels and so on have all been proposed in numerous patents. Usually they require a good deal of manual manipulation to move from the collapsed condition to the erected set up, rideable condition. In most cases, they require some form of fastening devices to be secured at various positions manually, before the bicycle can be ridden. Such extra work has detracted from the usefulness and appeal of such bicycles. It is often tiresome work. It must be done exactly in accordance with instructions. All fastening devices must be secured in position before the bicycle is ready to ride. A good majority of folding bicycles are bought with the intention of being folded, but after a short period of time the user has decided that it is too cumbersome to constantly unfold their bicycle before each use, and as a result, the bicycle remains in the unfolded position for the remainder of it's life.

Providing a foldable or collapsible bicycle which is self-powered to extend into a riding position is desirable. However, such a function must be designed in such a way that it does not add weight or complexity to the bicycle and does not detract from its usefulness as a compact storable unit when collapsed or folded and not in use.

### BRIEF SUMMARY OF THE INVENTION

The invention provides a self erecting, collapsible bicycle, which is self extending without manual operation upon the operation of a simple control. Preferably, the collapsible portions of the frame are connected by self-powering devices such as gas struts, such as are well known in the art. A simple control is connected to all of the self-powered devices. The self-powered devices in this case, store energy in the compression of the gas, which energy can be employed upon the operation of a simple control.

The invention further seeks to provide a self extending, collapsible bicycle in which the rear wheels are driven by pedals through a rotating shaft and gear system thus avoiding the use of a chain.

The invention further seeks to provide such a self extending, collapsible bicycle in which the frame has an upright saddle post and a forwardingly extending cross bar and a hinge connecting them and a self-powered device extending between the saddle post and the bar.

The invention further seeks to provide such a self extending, collapsible bicycle in which the handle bars consist of a two bar portions which are swingably mounted to a front wheel post and a self-powered device connecting the bar portions so that they may be extended.

The invention further seeks to provide such a self extending, collapsible bicycle in which the saddle which is mounted on the saddle post by means of a self-powered device and in which the self-powered device can be extended to the correct saddle height desired for use.

The invention further seeks to provide such a self extending, collapsible bicycle in which the saddle post consists of two side-by-side bar portions and defining a space between them, the space permitting the interposition of the front wheel of the bicycle when folded.

The invention further seeks to provide such a self extending, collapsible bicycle in which the front wheel post is pivotally mounted to the cross bar and including a self-powered device connecting the steering post to the transverse bar.

The invention further seeks to provide such a self extending, collapsible bicycle in which all of the self-powered devices are gas struts and including releasable locking devices in such gas struts and an operating trigger or button on the bicycle which can be operated to release energy from all of the gas struts for extending the bicycle into its in use position and release the extend struts for collapsing.

The invention is not limited to gas struts. The operation can be powered by compressed air devices, electrical devices, stored spring energy devices, batteries and servomotors and the like.

The various features of novelty which characterize the invention are pointed out with more particularity in the claims annexed to and forming a part of this disclosure. For a better understanding of the invention, its operating advantages and specific objects attained by its use, reference should be made to the accompanying drawings and descriptive matter in which there are illustrated and described preferred embodiments of the invention.

### IN THE DRAWINGS

FIG. 1 is a front perspective illustration of a self extending, collapsible bicycle illustrating the invention;

FIG. 2 is a rear perspective of FIG. 1;

FIG. 3 is a side elevation of the bicycle of FIG. 1;

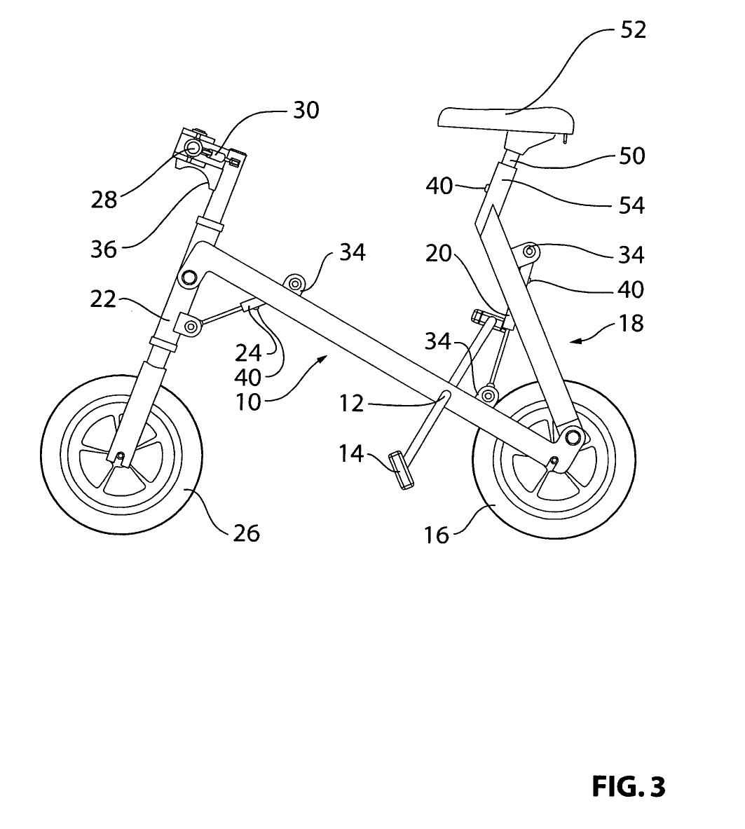

FIG. 4 is a perspective of the bicycle, folded;

FIG. 5 is a side elevation of the bicycle folded;

FIG. 6 is a perspective of the handlebars; and

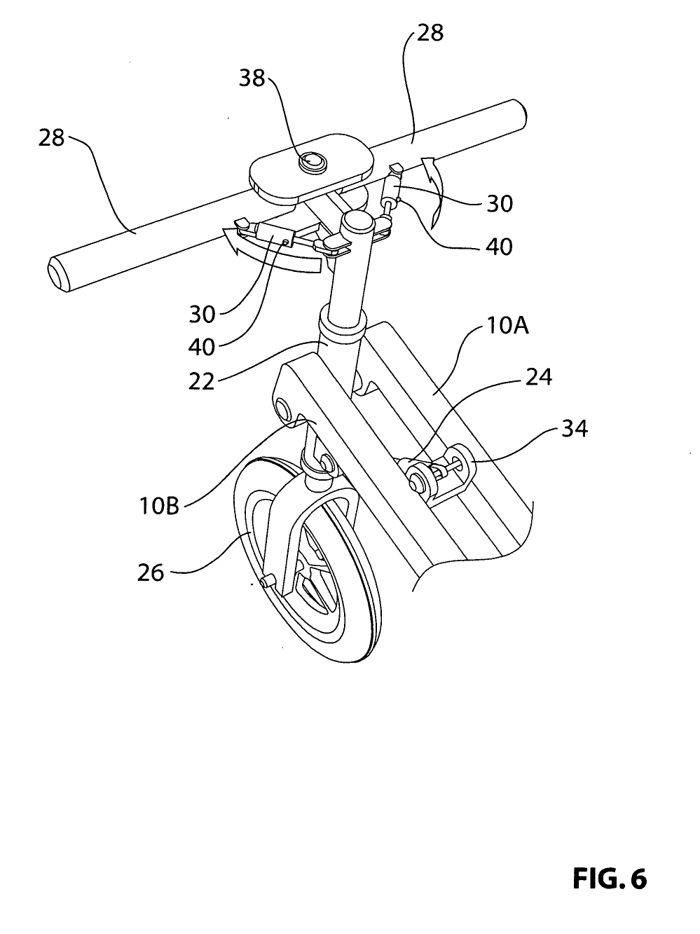

FIG. 7 is a perspective of the rear wheel and transmission.

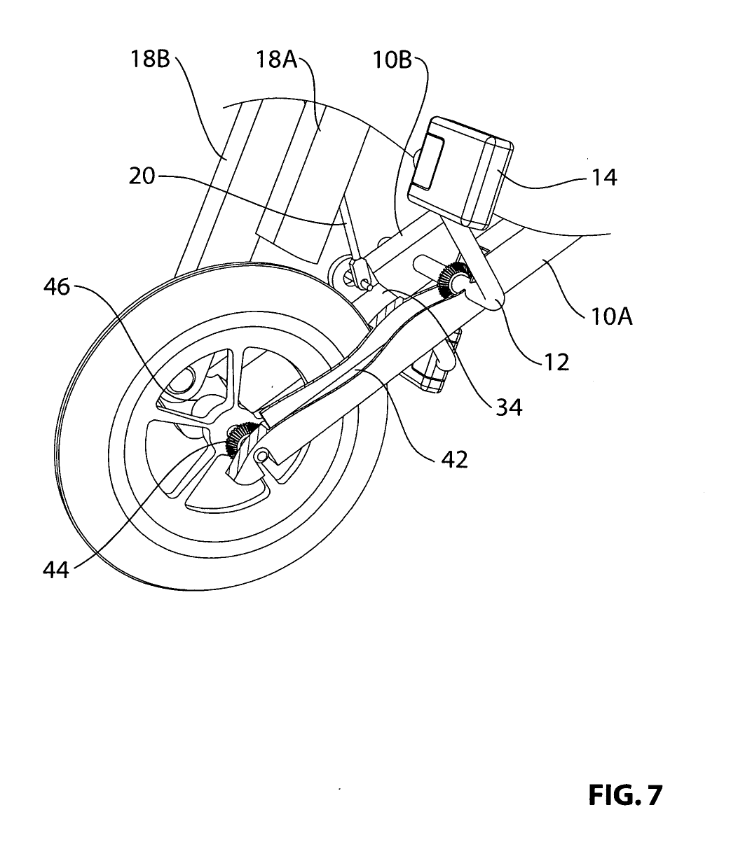

### DESCRIPTION OF A SPECIFIC EMBODIMENT

As explained above, the provision of a self extending, collapsible bicycle which is capable of self-extending into its rideable position, involves the solution of several different and conflicting problems. Clearly, the rideability of the bicycle in the extended position is a prime requirement. It should also be noted that the storing of the bicycle and the carrying of it when collapsed or folded is also of prime importance to the success of this type of product. The bicycle when stored should as far as possible be clean and avoid the possible contamination of a rider, or storage space, with oil or grease. While these requirements must be met, the weight of the bicycle should not be excessive. The mechanics of the extending and collapsing of the bicycle should also be simple and self maintaining as possible.

For this purpose, the frames of the bicycle are formed as parallel side-by-side tubes, leaving a space between them. The spacing between the tubes enables both great strength to be incorporated in the structure without increasing weight and at the same time, enables the entire bicycle to be folded more readily than was possible with a conventional bicycle frame formed of a single tube, as will become apparent from the following description.

The use of the parallel tube frame structure is particularly useful in enabling the incorporation of power operated means located between the parallel tubes for extending the bicycle into its rideable condition and at the same time, enable the folding or collapsing of the bicycle into its stored position to be both convenient and compact.

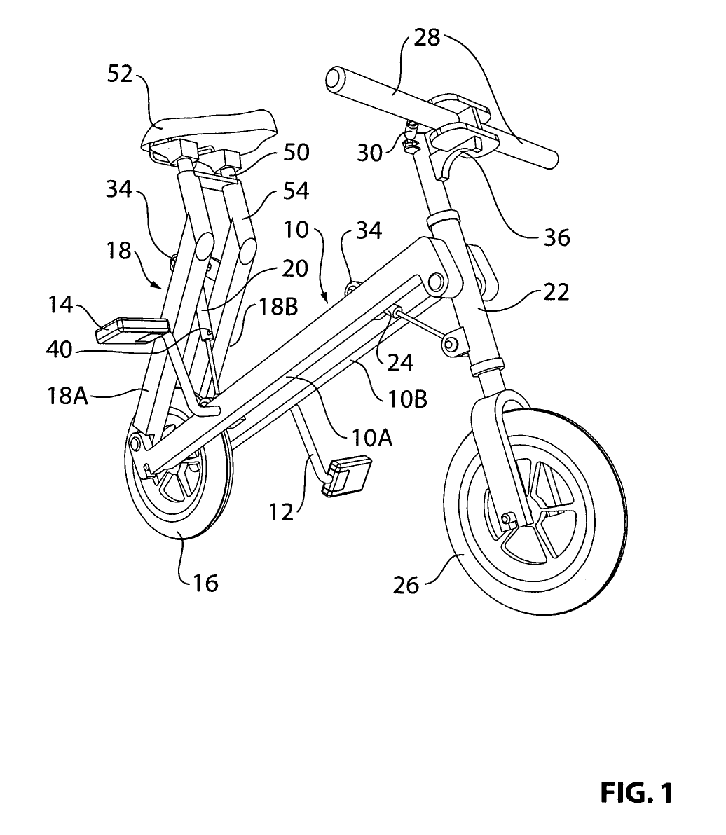

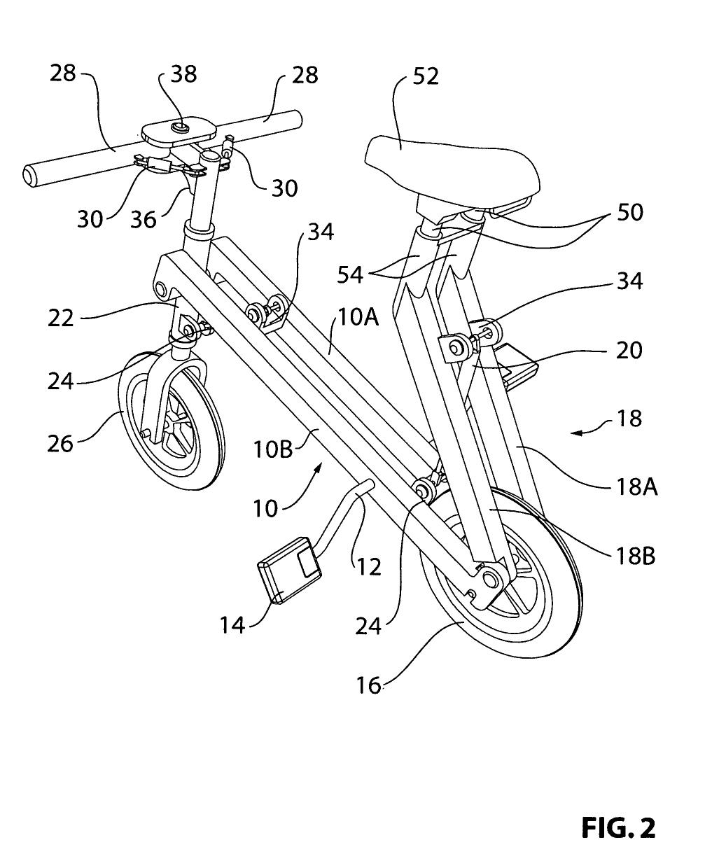

Referring now to FIGS. 1, 2, 4 and 5, it will be seen that the form of bicycle shown here as an illustration of the invention has a diagonal cross bar (10) carrying a pedal crank (12) with folding pedals (14). A rear wheel (16) is attached at the rear end of the cross bar (10) driven by crank (12) and a drive shaft described below. A saddle post (18) is hinged to the cross bar (10) operated by the self-powered device (20). A front wheel post (22) is hingedly attached to the cross bar (10) and operated by a self-powered device (24). Front wheel (26) is attached on post (22). Handle bars (28) are hinged to the top of post (22) and are operated by self-powered devices (30).

It will be seen that each of the cross bar (10) and the upright saddle post (18) are formed as pairs of tubes (10A-B and 18A-B), spaced apart from one another and held apart by bracers (34). The self-powered devices connect pivotally with the bracers (34). Preferably, the tubes are generally of rectangular cross section although this feature may not always be present.

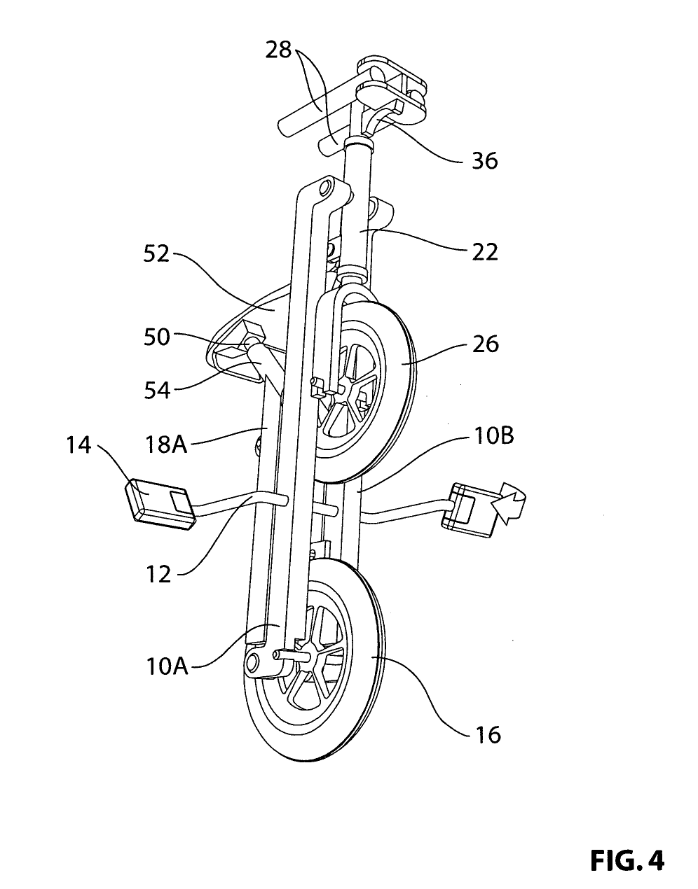

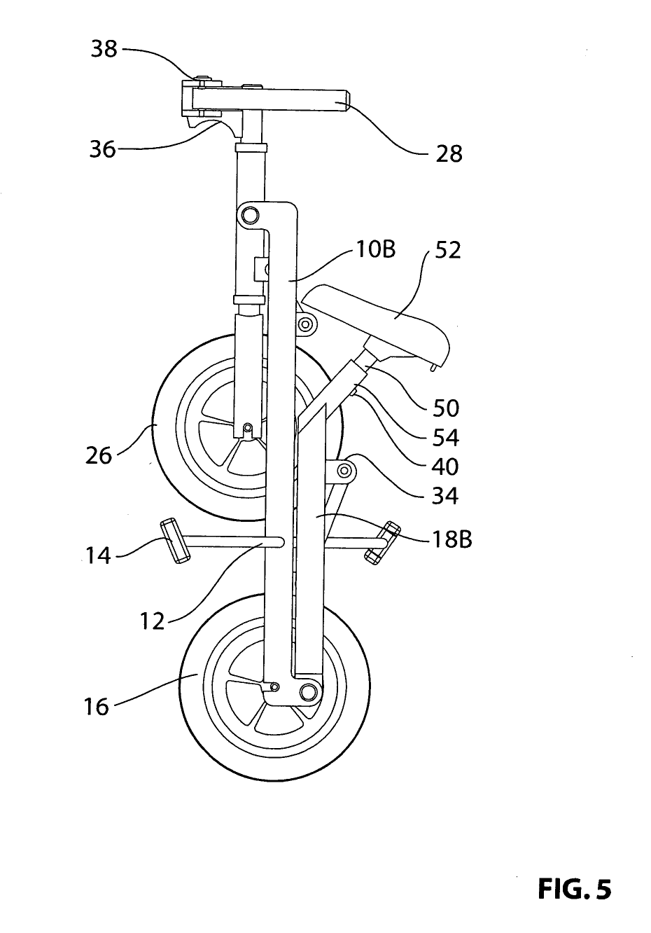

It will also be understood that the use of the cross bars (10) and saddle post (18) being formed as two parallel tubes, enables the inter-position of the front wheel (26), between the tubes of the cross bar (10) and saddle post (18) (FIGS. 4, 5). This enables the folded position of the bicycle to be compact and efficient.

In order to hang up the bicycle in its folded condition, a hook (36) may be provided on the front wheel post (22).

The self-powered devices (24) in this embodiment are so called “gas struts” and are of the type which will lock extended and lock contracted. When locked they may be released by operation of a manual trigger or buttons (38). When released from their contracted position the gas pressure will power the struts to extend.

Thus, when extended, the bicycle has a rigid frame which will support a rider. When folded and collapsed the bicycle may be easily carried or stored.

The invention is not limited to gas struts. The operation can be powered by compressed air devices, electrical devices, stored spring energy devices, batteries and servomotors and the like.

To convert from collapsed position (FIG. 4) to extended position (FIG. 1), the trigger (38) is operated. This will unlock the struts (24). The struts will then extend and thus extend the frame, cross bar, saddle post and front wheel post and handle bars into their extended in use position (FIG. 1). This ability to provide for self-powered extension adds greatly to the usefulness of the bicycle.

To convert from extended to the collapsed position, individual release buttons (40) or the struts must be operated to release each strut individually.

The back wheel is driven by a pedal crank (12). Crank (12) is connected to the back wheel by a drive shaft (42), and gears (44). Brakes (not shown) would also be provided, in any suitable manner. An internal gear ratio hub (46) contains a gear train by means of which the gear ratios can be changed while riding as desired.

Preferably the saddle height is adjustable. In this embodiment, two self-powered devices (50) can be provided for extending the saddle (52) to a desired height. The self-powered devices (50) are secured in parallel tubes (54) secured to the top of the saddle post (18).

The foregoing is a description of a preferred embodiment of the invention which is given here by way of example only. The invention is not to be taken as limited to any of the specific features as described, but comprehends all such variations thereof as come within the scope of the appended claims.

It will be understood that a bicycle such as this may also include a luggage rack, a kick stand, and also a gear hub in the pedal crank as well, all of which are known in the art.

What is claimed is:

1. A self extending, collapsible bicycle, which is self extending upon the operation of a simple control, and comprising:
collapsible frame portions moveable between collapsed and extended positions; self-powering devices connecting the frame portions operable to extend the frame portions, and
a control connected to the self powering devices.

2. A self-extending, collapsible bicycle as claimed in claim 1, having a rear wheel driven by pedal cranks through a rotating shaft and gear system.

3. A self-extending, collapsible bicycle as claimed in claim 1, in which the frame has an upright saddle post and a forwardingly extending cross bar and a hinge connecting them and a self-powering device extending between the saddle post and the cross bar.

4. A self extending, collapsible bicycle as claimed in claim 3, including a front wheel post hingedly connected to said cross-bar, and a self-powering device extending between them and a front wheel on the front-wheel post.

5. A self-extending, collapsible bicycle as claimed in claim 4, in which the handle bars consist of two bar portions swingably mounted to the front wheel post and self-powering devices connecting the bar portions with the front wheel post so that they may be extended.

6. A self-extending, collapsible bicycle as claimed in claim 3, in which the saddle is mounted on the saddle post by means of a self-powering device which can be extended to the correct saddle height desired for use.

7. A self-extending, collapsible bicycle as claimed in claim 6, in which the saddle post consist of two side by side bar portions and defining a space between them, the space between them permitting the inter position of a front wheel of the bicycle when folded.

8. A self-extending, collapsible bicycle as claimed in claim 4, a trigger for releasing the self-powering devices connected to the front wheel post.

9. A self-extending, collapsible bicycle as claimed in claim 4, in which all of the self-powering devices are gas struts and including releasable locking devices in such gas struts for collapsing the same and an operating trigger on the bicycle which can be operated to release energy in all of the gas struts for extending the bicycle into its in use position.

10. A self-extending collapsible bicycle as claimed in claim 1 where at least some of the frame portions comprise parallel spaced apart tubes.

11. A self-extending collapsible bicycle as claimed in claim 3 wherein said saddle post and said cross bar each comprise parallel spaced apart tubes.

12. A self-extending collapsible bicycle as claimed in claim 11 including junction devices connecting said parallel spaced apart tubes.

13. A self-extending collapsible bicycle as claimed in claim 12 wherein at least some of said self-powered devices are pivotally connected to said junction devices.

14. A self-extending collapsible bicycle as claimed in claim 12 wherein said saddle is mounted on parallel spaced part self powered devices mounted on said saddle post, and being operable to adjust the height of said saddle.
